(19) United States
(12) Patent Application Publication
(10) Pub. No.: US 2005/0286650 A1
(43) Pub. Date: Dec. 29, 2005

(54) Apparatus and method for providing transmit diversity in a mobile communication system using multiple antennas

(75) Inventors: Jin-Kyu Han, Suwon-si (KR); Dae-gyun Kim, Seongnam-si (KR); Hwan-Joon Kwon, Suwon-si (KR); Dong-Hee Kim, Yongin-si (KR); Youn-Sun Kim, Seongnam-si (KR); Han-Kyu Park, Seoul (KR); Cheol Mun, Suwon-si (KR); Myoung-Won Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/154,530

(22) Filed: Jun. 17, 2005

(30) Foreign Application Priority Data
Jun. 18, 2004 (KR) 2004-45769

(51) Int. Cl. H04L 1/02

(52) U.S. Cl. 375/267

(57) ABSTRACT

A transmit diversity apparatus and method are provided for adaptively providing a transmit diversity gain or a beamforming gain depending on changes in a radio channel undergoing multipath fading in a mobile communication system using multiple antennas. A transmitter forms as many fixed beams as the number of transmit antennas and a receiver selects a fixed beam having relatively high power among received fixed beams or linearly combines the received fixed beams. This common eigen space transmit diversity scheme improves the link performance between the transmitter and the receiver.

### PRIORITY

This application claims the benefit under 35 U.S.C. § 119(a) of an application entitled “Apparatus and Method for Transmit Diversity in A Mobile Communication System Using Multiple Antennas” filed in the Korean Intellectual Property Office on Jun. 18, 2004 and assigned Serial No. 2004-45769, the entire contents of which are herein incorporated by reference.

### BACKGROUND OF THE INVENTION

1. Field of the Invention

The present invention relates generally to a diversity apparatus and method in a multiple-antenna mobile communication system. In particular, the present invention relates to a transmit diversity apparatus and method for adaptively providing transmit diversity gain or beamforming gain according to changes in a radio channel which undergoes multipath fading.

2. Description of the Related Art

Mobile communication technology has evolved from IS-95A and IS-95B which focused on voice service and code division multiple access (CDMA) 2000 1× and now a high-speed, high-quality wireless data packet communication system for providing data service and multimedia service. 3^{rd} generation (3G) mobile communication systems currently being researched such as data packet communication systems for example, high speed downlink packet access (HSDPA) of the 3rd generation partnership project (3GPP) and 1×evolution-data and voice (1×EV-DV) of the 3rd generation partnership project 2 (3GPP2). The 3G mobile communication systems wirelessly transmit packet data with high quality at rates of 2 Mbps or above. At the same time, research is being conducted on 4^{th} generation (4G) mobile communication systems for providing ultra high-speed, high-quality multimedia service over an all Internet protocol (IP) network.

For a high-speed data packet service, since multimedia contents are provided to a mobile station (MS), forward link capacity from a base station (BS) to the MS needs to be increased. Although the forward link capacity can be increased by increasing the number of BSs or expanding an available frequency band, the former is expensive and the latter faces many practical obstacles. As an alternative approach, therefore, the 3GPP/3GPP2 is standardizing multiple antenna technologies for improving system performance and the transmission capability of BSs using an array antenna.

Current multiple antenna technologies are transmit diversity and beamforming. Transmit diversity schemes will be described below by type and a comparison between transmit diversity and beamforming will be presented in terms of their benefits and shortcomings, taking channel spatial correlation into account.

Transmit diversity is a technology of improving link level performance by mitigating the multipath fading of the forward radio channel. Current existing transmit diversity schemes include selective transmit diversity (STD), space-time spreading (STS), space-time block coding (STBC), transmit adaptive array antenna (TxAA), and so on.

Depending on whether a transmitter needs feedback information from a receiver, the above transmit diversity schemes are classified into an open-loop mode requiring no feedback information and a closed-loop mode requiring feedback information. STS and STBC are open-loop mode schemes, and STD and TxAA are closed-loop mode schemes. Because the closed-loop mode transmit diversity schemes face degradation of system performance due to transmission delay and errors in feedback information, they are hard to apply to a radio environment where mobile speed is large.

The transmit diversity schemes can be categorized as antenna space technology. According to the antenna space technology, the transmitter transmits signals through individual transmit antennas. The receiver then estimates the multipath fading channels between the respective transmit antennas and the receiver and processes each transmit antenna signal according to the channel estimation, thereby achieving diversity gain.

The conventional transmit diversity schemes will be described below in great detail on the assumption that two transmit antennas are used, for notational simplicity.

STD

STD is a transmit diversity scheme in which the receiver compares the instantaneous power levels of two pilot channel signals received from two transmit antennas and feeds back the index of a transmit antenna having a relatively stronger instantaneous power, so that the transmitter selects the transmit antenna and transmits a traffic signal through the transmit antenna. The amount of the index information depends on the number of transmit antennas used. Given 2ⁿ transmit antennas, the index information occupies n bits. With the transmission delay and errors of the feedback information neglected, the maximum signal-to-noise ratio (SNR) at the receiver in the STD scheme is given by

$${γ}_{STD} = max ( \frac{{E}_{b}}{{N}_{o}} {\vert {h}_{1} \vert}^{2} , \frac{{E}_{b}}{{N}_{o}} {\vert {h}_{2} \vert}^{2} ) \qquad ( 1 )$$

Let hₖ denote a fading channel coefficient. The fading channels with coefficients h₁ and h₂ then have the SNR of a transmit antenna that has transmitted a channel signal experiencing larger multipath fading between multipath fading channels received from the two transmit antennas. When the number of transmit antennas at the transmitter is expanded to n, the maximum SNR at the receiver computed by Eq. (1) is determined by

$${γ}_{STD} = max ( \frac{{E}_{b}}{{N}_{o}} {\vert {h}_{1} \vert}^{2} , \frac{{E}_{b}}{{N}_{o}} {\vert {h}_{2} \vert}^{2} , … , \frac{{E}_{b}}{{N}_{o}} {\vert {h}_{n} \vert}^{2} ) .$$

In a radio channel environment with a low correlation between multipath fading channels from the transmit antennas, the channel coefficients h₁ and h₂ vary independently. Thus, a high transmit diversity gain and the average SNR gain are achieved. On the other hand, since h₁ and h₂ become equal in a radio channel environment with a high correlation of multipath fading, the use of multiple transmit antennas does not bring an improved transmit diversity gain and the average SNR gain, compared to the use of a single transmit antenna.

STBC

STBC is a major example of an open-loop mode transmit diversity. Alamouti code is a STBC technique using two transmit antennas. The Alamouti code can be implemented in STS or in space-time transmit diversity (STTD). In a conventional antenna space, the Alamouti code is expressed as Eq. (2). Let transmission signals for an even-indexed time and an odd-indexed time in the transmitter be denoted by xₑ and xₒ, respectively. Then, the two transmit antennas transmit

$$\frac{{x}_{o}}{\sqrt{2}} and - \frac{{x}_{e}^{*}}{\sqrt{2}} ,$$

respectively at the even-indexed time, and

$$\frac{{x}_{e}}{\sqrt{2}} and - \frac{{x}_{o}^{*}}{\sqrt{2}} ,$$

respectively at the odd-indexed time. Signals rₑ and rₒ received at the receiver at the even-numbered time and the odd-numbered time are expressed as

$$[ \begin{matrix}{r}_{e} \\ {r}_{o}\end{matrix} ] = [ \begin{matrix}{h}_{1} {x}_{o} - {h}_{2} {x}_{e}^{*} \\ {h}_{1} {x}_{e} + {h}_{2} {x}_{o}^{*}\end{matrix} ] / \sqrt{2} + [ \begin{matrix}{η}_{1} \\ {η}_{2}\end{matrix} ] \qquad ( 2 )$$

where η₁ and η₂ are noise signals included in the signals rₑ and rₒ Linearization of the received signals rₑ and rₒ leads to

$$[ \begin{matrix}{\hat{x}}_{e} \\ {\hat{x}}_{o}\end{matrix} ] = [ \begin{matrix}{h}_{2}^{*} {r}_{e} - {h}_{1} {r}_{o}^{*} \\ {h}_{1}^{*} {r}_{e} + {h}_{2} {r}_{o}^{*}\end{matrix} ] \qquad ( 3 )$$

Therefore, the maximum SNR of the received signals is

$${γ}_{STS} = \frac{{E}_{b}}{{N}_{o}} \frac{{\vert {h}_{1} \vert}^{2} + {\vert {h}_{2} \vert}^{2}}{2} \qquad ( 4 )$$

The channel coefficients h₁ and h₂ of instantaneous multipath fading from the transmit antennas are random variables having Rayleigh distribution. Hence, the average power of the fading channels is E[|h₁|²]=E[|h₂|²]=1.

For the Alamouti STBC, therefore, the average SNR is E[γ_{STS}]=E_{b}/Nₒ equal to that for the case of the single transmit antenna. Consequently, the Alamouti STBC does not provide an increase in the average SNR, only with a diversity order of 2. However, in an environment where the spatial correlation between multipath fading channels (hereinafter, referred to as “channel spatial correlation”) from the two transmit antennas is high, the channel coefficients h₁ and h₂ become approximate, resulting in no transmit diversity gain.

Because STBC is designed to achieve diversity gain, the above feature is common to all other STBC schemes as well as the Alamouti STBC.

As stated earlier, STBC is an open-loop mode diversity scheme in which the receiver does not transmit feedback information to the transmitter. This implies that there exists no effect of the transmission delay or errors of feedback information, making STBC applicable to fast moving MSs. However, it is difficult to design a space-time code suitable for more than two transmit antennas in the STBC scheme.

TxAA

In TxAA, the receiver estimates the channel coefficients h₁ and h₂ using pilot channel signals received from the two transmit antennas, instantaneously determines transmit weights for providing maximum power using the estimates of the channel coefficients h₁ and h₂, and feeds back the transmit weights to the transmitter. The transmitter multiplies a transmission signal by the transmit weights prior to transmission. The transmit weights are determined by w=h/∥h∥ and a signal received at the receiver in the TxAA scheme is given as

$$r = {hw}^{H} s + η = \frac{{hh}^{H}}{‖ h ‖} s + η = \vert \vert h \vert \vert s + η \qquad ( 5 )$$

where the vector h=[h₁+h₂]. Hence, ∥h∥=\sqrt{|h₁|²+|h₂|²}.

In TxAA, the maximum received SNR is thus computed by

$${γ}_{TxAA} = \frac{{E}_{b}}{{N}_{o}} ( {\vert {h}_{1} \vert}^{2} + {\vert {h}_{2} \vert}^{2} ) \qquad ( 6 )$$

Therefore, the average SNR is E[γ_{TxAA}]=2E_{b}/Nₒ, a double of the average SNR in the case of the single transmit antenna. TxAA yields an average SNR gain proportional to the number of the transmit antennas irrespective of the channel spatial correlation of multipath fading. In a radio environment with low channel spatial correlation, TxAA may have a transmit diversity gain since it has a diversity order of 2. In contrast, in a radio environment with high channel spatial correlation, the channel coefficients h₁ and h₂ become approximate, resulting in no transmit diversity gain.

Despite the benefit of concurrent achievement of the average SNR gain and a transmit diversity gain, TxAA has the distinctive drawback of a large amount of feedback information transmitted from the receiver to the transmitter. A technique of feeding back 2- or 4-bit transmit weight information is known for a conventional TxAA. Since the TxAA scheme is sensitive to the effects of the transmission delay or errors of the feedback information, it is viable only for slow MSs. Moreover, as the number of transmit antennas is increased to 2 or larger, the feedback information increases proportionally in size, making it almost impossible to apply TxAA for systems using two or more transmit antennas.

As described above, the conventional transmit diversity schemes have optimum performance in a radio environment with low channel spatial correlation. In a real radio environment, however, the channel spatial correlation is relatively high. While this problem can be overcome by considerably increasing the antenna spacing of a transmit antenna array, the spacing is limited in view of the size limitation of the transmitter. Therefore, the transmit diversity performance becomes poor because of the high channel spatial correlation in the real implementation environment. In particular, STBC and STD face great performance degradation due to the high channel spatial correlation. As described before, STBC provides only a transmit diversity gain and STD yields a lower average SNR gain and a transmit diversity gain for a higher channel spatial correlation.

In the application of transmit diversity to a wireless data packet communication system, the transmit diversity gain decreases the instantaneous maximum power level of multipath fading channels on individual links between a transmitter and receivers. If the wireless packet system transmits packets by selecting a link having an instantaneous maximum power among all links between the transmitter and each receiver, the total system capacity is decreased. Especially STBC, which offers only a transmit diversity gain, has less system capacity than in the case of using a single transmit antenna. STD and TxAA, which provide the average SNR gain, have a higher system capacity than in the case of a single transmit antenna. Yet, they decrease system capacity due to the diversity gain, as the channel spatial correlation decreases.

The transmit diversity schemes relying on independent fading between multiple antennas are effective for a low channel spatial correlation between transmit antennas. In a high channel spatial correlation channel environment such as a line-of-sight (LOS) environment, hence, no transmit diversity gain is expected. In contrast, another technology using an array antenna, beamforming requires a high channel spatial correlation between transmit antennas to achieve beamforming gain.

In this context, a suitable multiple antenna technique should be selectively used according to the channel spatial correlation of a given radio environment in order to achieve optimum performance in various channel environments. Nonetheless, it is not preferred to selectively use systems with opposite characteristics because of operation complexity. Accordingly, a need exists for developing a multiple antenna scheme for providing transmit diversity gain in a radio environment with low channel spatial correlation and beamforming gain in a radio environment with high channel spatial correlation.

### SUMMARY OF THE INVENTION

An object of the present invention is to substantially solve at least the above problems and/or disadvantages and to provide at least the advantages below. Accordingly, an object of the present invention is to provide a transmit diversity apparatus and method for providing transmit diversity gain in a radio environment with low channel spatial correlation and beamforming gain in a radio environment with high channel spatial correlation in a mobile communication system using multiple antennas.

Another object of the present invention is to provide a transmit diversity apparatus and method for increasing system capacity by forming fixed beams which increase an average SNR gain in a mobile communication system using multiple antennas.

The above objects are achieved by providing a transmit diversity apparatus and method for adaptively providing a transmit diversity gain or a beamforming gain depending on the change of a radio channel undergoing multipath fading in a mobile communication system using multiple antennas.

According to the present invention, in a diversity apparatus for a transmitter having a plurality of transmit antennas in a mobile communication system, a plurality of fixed beamformers form fixed beam signals using a plurality of common eigen bases, each for one fixed beam signal, and the plurality of transmit antenna receive the fixed beam signals from the fixed beamformers and transmit the fixed beam signals over a radio network.

The diversity apparatus is further provided with a switch for receiving feedback information about a selected common eigen basis from a receiver and switching the selected common eigen basis to a fixed beamformer using the selected common eigen basis as a beamforming weight.

The diversity apparatus is further provided with an STBC encoder for STBC-encoding a plurality of signals demultiplexed from data symbols and providing STBC-coded signals to the plurality of fixed beamformers.

The diversity apparatus is further provided with an adaptive beamformer for receiving feedback information about a transmit weight estimated by the receiver from the receiver, generating an adaptive beam signal according to the feedback information, and providing the adaptive beam signal to the plurality of fixed beamformers.

According to one aspect of the present invention, in a diversity apparatus for a receiver receiving radio data symbols from a transmitter that has a plurality of transmit antennas and forms fixed beams in a common eigen space using common eigen bases corresponding to the transmit antennas as weights in a mobile communication system, an antenna transmits and receives data over a radio network, a fading estimator estimates at least one of fading channels formed by a plurality of fixed beams, and a basis selector measures the instantaneous power levels of the estimated fading channels and feeds back information about the common eigen basis of a fading channel having the highest instantaneous power level to the transmitter.

According to an alternative aspect of the present invention, in a diversity apparatus for a receiver receiving radio data symbols from a transmitter that has a plurality of transmit antennas and forms fixed beams in a common eigen space using common eigen bases corresponding to the transmit antennas as weights in a mobile communication system, an antenna transmits and receives data over a radio network, a fading estimator estimates at least one of fading channels formed by a plurality of fixed beams, an STBC encoder STBC-encodes data symbols received on the at least one estimated fading channel, and a multiplexer multiplexes STBC-encoded signals.

According to a further aspect of the present invention, in a diversity apparatus for a receiver receiving radio data symbols from a transmitter that has a plurality of transmit antennas and forms fixed beams in a common eigen space using common eigen bases corresponding to the transmit antennas as weights in a mobile communication system, an antenna transmits and receives data over a radio network, a fading estimator estimates at least one of fading channels formed by a plurality of fixed beams, and a transmit weight estimator estimates a transmit weight from the at least one estimated fading channel, for use in beamforming in the transmitter and feeds back information about the transmit weight estimate to the transmitter.

According to the one aspect of the present invention, in a method of providing transmit diversity from a transmitter to a receiver, the transmitter having a plurality of transmit antennas receives from the receiver feedback information about a common eigen basis of a fading channel estimated at the receiver among a plurality of common eigen bases, selects at least one of a plurality of fixed beamformers based on the feedback information, provides data symbols for transmission to the selected fixed beamformer, forms a fixed beam signal using the common eigen basis using a weight through the selected fixed beamformer, and transmits the fixed beam signal through the transmit antennas over a radio network.

According to the alternative aspect of the present invention, in a method of providing transmit diversity from a transmitter to a receiver, the transmitter having a plurality of transmit antennas STBC-encodes data symbols for transmission, provides STBC-coded signals to a plurality of fixed beamformers, forms the STBC-coded signals into fixed beam signals using common eigen bases through the fixed beamformers, and transmits the fixed beam signals through the transmit antennas over a radio network.

According to the further aspect of the present invention, in a method of providing transmit diversity from a transmitter to a receiver, the transmitter having a plurality of transmit antennas receives from the receiver feedback information about a transmit weight estimated at the receiver for use in beamforming in the transmitter, performs a primary beamforming using the transmit weight, provides the primary beamformed signal to a plurality of fixed beamformers, performs a secondary beamforming using common eigen bases through the fixed beamformers and outputting fixed beam signals, and transmits the fixed beam signals over a radio network through the transmit antennas.

### BRIEF DESCRIPTION OF THE DRAWINGS

The above and other objects, features and advantages of the present invention will become more apparent from the following detailed description when taken in conjunction with the accompanying drawings in which:

FIG. 1A is a conceptual view illustrating a antenna space-based transmit diversity scheme;

FIG. 1B is a conceptual view illustrating a common or shared eigen space-based transmit diversity;

FIG. 2 is a block diagram of a transmit diversity system according to an embodiment of the present invention;

FIG. 3 is a flowchart illustrating a transmit diversity method according to an embodiment of the present invention;

FIG. 4 is a block diagram of a transmit diversity system according to an embodiment of the present invention;

FIG. 5 is a flowchart illustrating a transmit diversity method according to an embodiment of the present invention;

FIG. 6 is a block diagram of a transmit diversity system according to an embodiment of the present invention; and

FIG. 7 is a flowchart illustrating a transmit diversity method according to an embodiment of the present invention.

Throughout the drawings, the same or similar elements are denoted by the same reference numerals.

### DETAILED DESCRIPTION OF EXEMPLARY EMBODIMENTS

Embodiments of the present invention will be described herein below with reference to the accompanying drawings. In the following description, well-known functions or constructions are not described for conciseness.

Before describing embodiments of the present invention, the basic concept of the present invention will be described briefly.

The present invention provides a transmit diversity scheme using a common eigen space as a signal transmission space in a mobile communication system using a transmit array antenna. While a transmitter transmits signals through respective transmit antennas and a receiver estimates the fading of a signal from each transmit antenna, for signal reception in the conventional antenna space-based transmit diversity schemes (STD, STBC, TxAA), the transmitter transmits signals by fixed beamforming and the receiver estimates fading between the transmitter and the receiver from each fixed beam, for signal processing in the common or shared eigen space-based transmit diversity scheme of the present invention.

The common eigen space-based transmit diversity scheme is designed to maximize a required gain according to the channel spatial correlation of a radio environment or the type of the system used (a circuit-switched or packet-switched system). In application to a circuit-switched system, the present invention operates as a transmit diversity system in a radio environment with low channel spatial correlation and as a fixed beamforming system in a radio environment with high channel spatial correlation, thereby avoiding the effects of the varying channel spatial correlation. In application to a packet-switched system, the present invention operates a fixed beamforming system by narrowing the antenna spacing in order to increase system capacity and an average SNR gain.

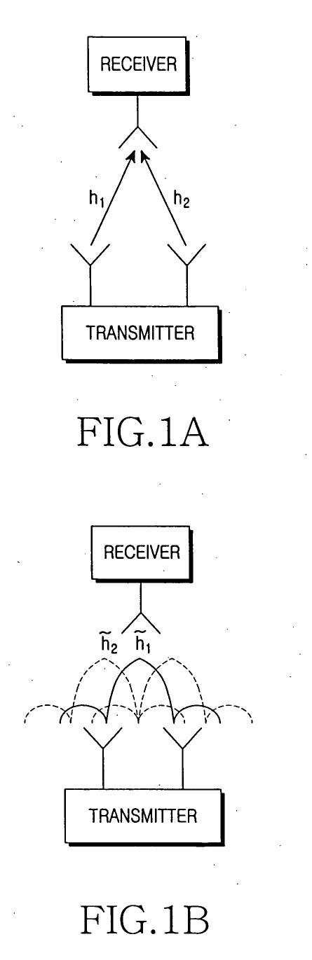

FIGS. 1A and 1B compare the basic concepts of the conventional antenna space-based transmit diversity scheme and the common eigen space-based transmit diversity scheme of the present invention.

Referring to FIG. 1A, in the conventional transmit diversity scheme, signals from transmit antennas 11 and 12 at a transmitter are transmitted on channels with coefficients h₁ and h₂ to a receive antenna at a receiver, providing transmit diversity in the radio environment with low channel spatial correlation. Referring to FIG. 1B, in the transmit diversity scheme of the present invention, a transmitter forms as many fixed beams as the number of transmit antennas and transmits signals on channels with coefficients \tilde{h}₁ and \tilde{h}₂ formed by the fixed beams, thereby achieving transmit diversity. The transmitter uses fixed weights common to all receivers for fixed beamforming and transmits signals through the fixed beams, to thereby improve the link performance between the transmitter and each receiver. Hereinafter, a fixed weight is interchangeable with a common eigen basis in meaning.

While existing fixed beam network (FBN) and Butler matrix-based switched beam antenna systems are also fixed beamforming techniques, their beamforming aims at different purposes from those of the present invention. These systems seek to increase frequency reuse efficiency by increasing the number of sectors per cell of a base station (BS) using a plurality of orthogonal fixed beams.

Compared to the conventional fixed beamforming systems, the transmitter forms as many fixed beams as transmit antennas and the receiver selects a fixed beam with a relatively high power level from among signals received by the fixed beams (common eigen space STD) or linearly combine the signals of the fixed beams (common eigen space TxAA), thereby improving the link performance between the transmitter and the receiver in the common eigen space-based transmit diversity scheme.

Weights used for beamforming are fixed and thus are time-invariant. They are common to all receivers. Therefore, it is of importance to determine an appropriate common eigen basis set in the present invention.

A detailed description will now be made of an operation for determining a common eigen basis set as weights for fixed beamforming.

A transmitter in a BS determines a common eigen basis set E=[e₁ . . . e_{nT}] comprising as many common eigen bases as transmit antennas, eₖ (k=1, . . . , n_{T}). The common eigen bases are fixed over time and applied commonly to all receivers within a cell or sector of the BS. According to an embodiment of the present invention, the common eigen basis set E must be designed to satisfy the following three conditions.

(1) The common eigen bases of the common eigen basis set E are mutually orthogonal and the norm of every basis is 1. This feature renders the transmit power of fixed beam signals using the bases to be equal and minimizes interference between the fixed beam signals.

(2) The common eigen bases of the common eigen basis set E is determined such that every basis transfers an equal average power to a cell or a sector, taking into account the array structure of transmit antennas and a beam pattern (i.e. a power distribution radiated to the cell or the sector). For example, in the case where no spatial correlation exists between forward link fading channels from the BS transmitter to the MS receiver, every basis transfers equal transmit power to the receiver. The array structure refers to the number of antenna devices and the spacing between them.

To satisfy the above condition, the spacing between main beams formed with a weight vector must be maximized in the sector. For this purpose, the main beams must be equiangularly spaced. For example, when using four transmit antennas for a sector having a 120° cell coverage, four main beams formed with four weights must be spaced from each other by 30°. Hence, the four weights are determined such that the four beams steer at the angles of −45°, −15°, 15° and 45°.

The array structure of transmit antennas (the number of transmit antennas and the antenna spacing) and the beam pattern of the transmit antennas are considered in weight determining. Thus, a transmit correlation matrix is formed, for example, by Eq. (7), considering the array structure and the beam pattern so as to radiate transmission signals uniformly in all directions to the sector, and an eigen analysis of the transmit correlation matrix produces as many eigen vectors as the number of transmit antennas. Since the eigen vectors are mutually orthogonal and of length 1, the first condition is satisfied.

The eigen vectors draw lines with a maximum spacing between them in a corresponding complex space, that is, in a complex channel space in which the antennary array structure ad the beam pattern are considered. Therefore, the second condition is also satisfied. For a low spatial correlation as observed when the transmission signal has an angular spread of 120°, that is, the transmission signal is radiated across the entire sector area, the MS can receive the same power from each weight.

(3) Unlike a Butler matrix that confines each basis to exclusive coverage of a predetermined area of the cell, every basis transfers power across all areas of the cell. With this feature, the transmitter and the receiver are allowed to concurrently transmit and receive signals using a plurality of common eigen bases in an angular spread radio environment.

In the conventional fixed beamforming, a sector is divided into smaller sectors by an orthogonal beam pattern in order to reduce the interference from other sectors and thus increase capacity. With four transmit antennas, a sector with 120° coverage is divided into four exclusive sectors, for example, −60° to −30°, −30° to 0°, 0° to 30°, and 30° to 60° areas. Therefore, an MS within one sector is prevented from receiving signals from other sectors at the same time, thereby decreasing the interference from the other sectors.

As compared to the conventional fixed beamforming, in the fixed beamforming of the present invention, beams formed with as many weights as the number of transmit antennas do not form exclusive sector areas. In other words, one MS can receive signals with the weights simultaneously. When the weights are computed by Eq. (7), the MS can receive signals through the beams formed with the weights irrespective of the azimuth angle of its location, even though the instantaneous power of the received signals may be different. This feature makes it possible to transmit a plurality of data streams with a plurality of weights simultaneously between the BS and the MS.

While a common eigen basis set can be determined in a different manner depending on the purpose of designing a system, a common eigen basis set satisfying the above three conditions is determined by the following equation. When using n_{T} transmit antennas with an antenna spacing of d_{T} for a cell with a sector radius of Δ and a radiation pattern of p(θ), a common eigen basis set suitable for the radio environment has the eigen vectors of a transmit spatial correlation matrix R defined as

$$R = {\int }_{- Δ / 2}^{Δ / 2} p ( θ ) {a}^{H} ( θ ) a ( θ ) ⅆ θ \qquad ( 7 )$$

where a(θ) represents the response vector of the transmit antennas, a(θ)=[1, exp(j2πd_{T} sin θ/λ) . . . exp(j2π(n_{T}−1)d_{T} sin θ/λ)]. The response vector a(θ) is determined according to the number of transmit antennas n_{T}, the antenna spacing d_{T}, and the wavelength of a carrier λ . For example, in the case of using two transmit antennas with a predetermined spacing for a cell having a predetermined sector radius and a symmetrical radiation pattern of fixed beams with respect to the broadside of the transmit antenna array, the common eigen basis matrix is

$$E = [ {e}_{1} {e}_{2} ] = [ \begin{matrix}1 / \sqrt{2} & 1 / \sqrt{2} \\ 1 / \sqrt{2} & - 1 / \sqrt{2}\end{matrix} ] \qquad ( 8 )$$

The BS multiplies a transmission signal by the common eigen basis matrix, prior to transmission on a radio channel. Due to the common eigen basis matrix, the radio channel is unitary transformed into
\tilde{h}=hE=[he₁ he₂ . . . heₙ_{_{T}}]=[\tilde{h}₁ \tilde{h}₂ . . . \tilde{h}ₙ_{_{T}}] (9)
where h is the antenna space-channel vector with one row and n_{T} columns, defined as h=[h₁ h₂ . . . hₙ_{_{T}}] in which hₖ is a channel coefficient from a k^{th} transmit antenna to the receiver. \tilde{h} is the common eigen space-channel vector created by unitary-transforming the antenna space-channel vector h by the common eigen basis matrix. \tilde{h}ₖ is the fading channel coefficient of a channel beamformed with a k^{th} basis eₖ and transmitted to the receiver. Thus \tilde{h}ₖ=heₖ.

The channel vector \tilde{h} in the common eigen space, which has resulted from unitary transform of h by the common eigen basis matrix E, has different characteristics from the channel vector h in the antenna space according to the spatial correlation between channels. The average power levels of signals with n_{T} common eigen bases at the receiver are equal in a low channel spatial correlation environment, that is, an environment with a large angular spread. Under this radio environment, the present invention provides a transmit diversity gain using the bases.

In an environment with a high channel spatial correlation, that is, a small angular spread, however, some bases with which beams are formed in the direction of the receiver deliver signals to the receiver while the other bases fail. This phenomenon becomes serious for higher channel spatial correlation and only one basis transfers a signal to the receiver in an environment with a very high channel spatial correlation. In this radio environment, the present invention provides a beamforming gain by the basis.

The space transmit diversity scheme using common eigen bases serves as a transmit diversity scheme in a low spatial correlation environment, whereas it adaptively operates as a beamforming scheme in a high spatial correlation environment. In view of this feature, a common eigen space diversity system operates in a beamforming scheme in the high spatial correlation environment, compared to the conventional antenna space diversity system which suffers from performance degradation in the same environment. Consequently, the present invention minimizes the degradation of system performance.

The common eigen space-based transmit diversity scheme of the present invention, which is implemented as a transmit diversity scheme or a beamforming scheme depending on channel spatial correlation by selecting a signal or linearly combining signals delivered to the receiver by common eigen bases, will be described below separately as STD using the common eigen space (common eigen space STD), STBC using the common eigen space (common eigen space STBC), and TxAA common eigen space (common eigen space TxAA).

Common Eigen Space STD

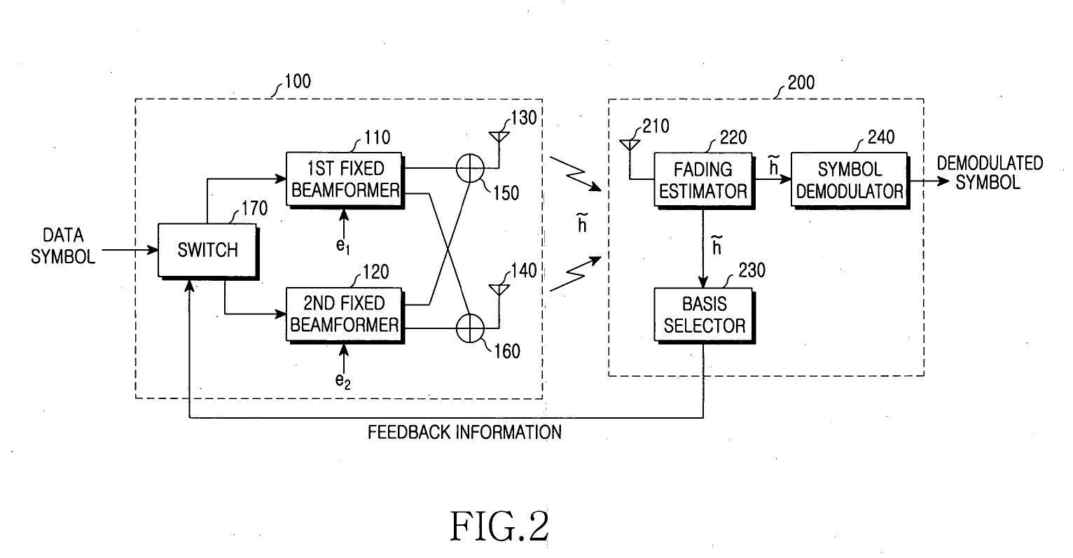

FIG. 2 is a block diagram of a transmit diversity system according to an embodiment of the present invention. The transmit diversity system is comprised of a transmitter 100 and a receiver 200 that operate in a common eigen space STD with two transmit antennas, for example.

Referring to FIG. 2, the transmitter 100 is provided in a BS. At the transmitter 100, first and second fixed beamformers 110 and 120 form as many orthogonal transmission beams as the number of transmit antennas 130 and 140 using a common eigen basis set with e₁ and e₂. The receiver 200, which is provided in an MS, compares the received power levels of pilot channel signals to which common eigen bases are applied, selects a basis offering the higher power, and feeds back information about the selected basis to the transmitter 100. The transmitter 100 then transmits a traffic signal to the receiver 200 by fixed beamforming using the selected basis as a weight.

Unlike the traffic signal, the pilot channel signal can be transmitted over a radio network through the transmit antennas 130 and 140 using the bases, or transmitted by fixed beams through the first and second fixed beamformers 110 and 120. That is, while the traffic signal is transmitted using a selected basis as a weight, the pilot channel signal is weighted with the bases, prior to transmission.

At the receiver 200, a fading estimator 220 connected to a receive antenna 210 estimates fading channel coefficients from fixed beams formed with the common eigen bases by \tilde{h}=[\tilde{h}₁ \tilde{h}₂]. In accordance with the embodiments of the present invention, the receiver 200 preserves the same common eigen basis set as the transmitter 100 and estimates channels that deliver fixed beam signals using the common eigen basis set. Preferably, the common eigen basis set is provided in the fading estimator 220.

The fading estimator 220 transmits the channel estimation result to a basis selector 230 and, at the same time, provides the received signal to a symbol demodulator 240. The symbol demodulator 240 demodulates the signal.

In the mean time, the basis selector 230 compares the instantaneous power levels of the channels with the two bases, selects the basis offering the higher instantaneous power, and feeds back information about the selected basis to the transmitter 100. Thus, a switch 170 of the transmitter 100 switches a traffic signal to the first or second beamformer 110 or 120 that uses the selected basis as a weight. The transmit antennas 130 and 140, each being connected to the output terminals of the first and second fixed beamformers 110 and 120 via combiners 150 and 160, radiate a fixed beam formed using the selected common eigen basis over a radio network.

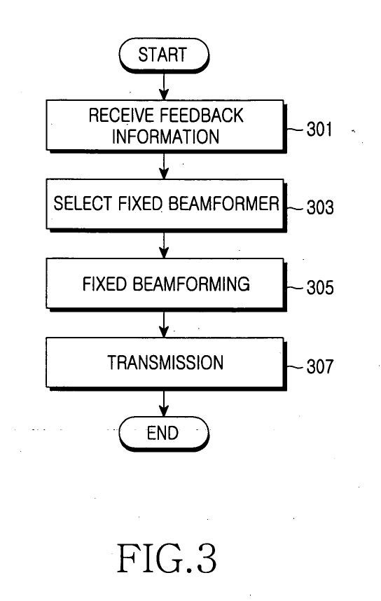

FIG. 3 is a flowchart illustrating a transmit diversity method according to an embodiment of the present invention. The transmit diversity method transmits to the receiver data symbols using a selected common eigen basis e₁ or e₂ by the transmitter and recovers the data symbols through demodulation at the receiver.

Referring to FIG. 3, the BS transmitter 100 receives feedback information about a selected common eigen basis from the MS receiver 200 in step 301. In step 303, the transmitter 100 selects the common eigen basis from the common eigen basis set based on the feedback information and then selects a fixed beamformer that forms a fixed beam with the common eigen basis. The transmitter 100 provides a traffic signal to the selected fixed beamformer and performs fixed beamforming in step 305 and transmits the beamformed traffic signal to the receiver 200 through the respective transmit antennas in step 307.

The maximum received SNR for the common eigen space STD scheme is determined by

$${\tilde{γ}}_{STD} = max ( \frac{{E}_{b}}{{N}_{o}} {\vert {\tilde{h}}_{1} \vert}^{2} , \frac{{E}_{b}}{{N}_{o}} {\vert {\tilde{h}}_{2} \vert}^{2} ) \qquad ( 10 )$$

When the spatial correlation between channels from the transmit antennas to the receive antenna is low, the average received power of the channels to which the two bases are applied is almost equal, expressed as E[|\tilde{h}₁|²]=E[|\tilde{h}₂|²]=1. As a result, the maximum received SNR computed by Eq. (10) becomes equal to that achieved in the conventional antenna space STD scheme as computed by Eq. (1), and thus these two STD schemes show the same performance.

For a fading channel with a high channel spatial correlation, however, the fading channels become h₁=h₂, E[|\tilde{h}₁|²]=E[|\tilde{h}₂|²]=1 in the conventional antenna space and the conventional STD scheme has the received SNR given by

$${γ}_{STD} = \frac{{E}_{b}}{{N}_{o}} {\vert {h}_{1} \vert}^{2} \qquad ( 11 )$$

On the other hand, the average power levels of the fading channels in the common eigen space are calculated to be E[|\tilde{h}₁|²]=2, E[\tilde{h}₂|²]=0. Thus, the received SNR for the common eigen space STD scheme is

$${\tilde{γ}}_{STD} = \frac{{E}_{b}}{{N}_{o}} {\vert {\tilde{h}}_{1} \vert}^{2} \qquad ( 12 )$$

where since E[\tilde{γ}_{STD}]=2×E[γ_{STD}], beamforming increases the average SNR for fading channels having a high channel spatial correlation. The common eigen space STD yields a SNR gain up to 3 dB higher than that in the conventional antenna space STD. It can be thus concluded that the common eigen space STD provides a transmit diversity scheme having an equal diversity gain for a fading channel with a low channel spatial correlation and a beamforming system having a double SNR gain at maximum for a fading channel with a high channel spatial correlation, relative to the conventional antenna space STD.

Common Eigen Space STBC

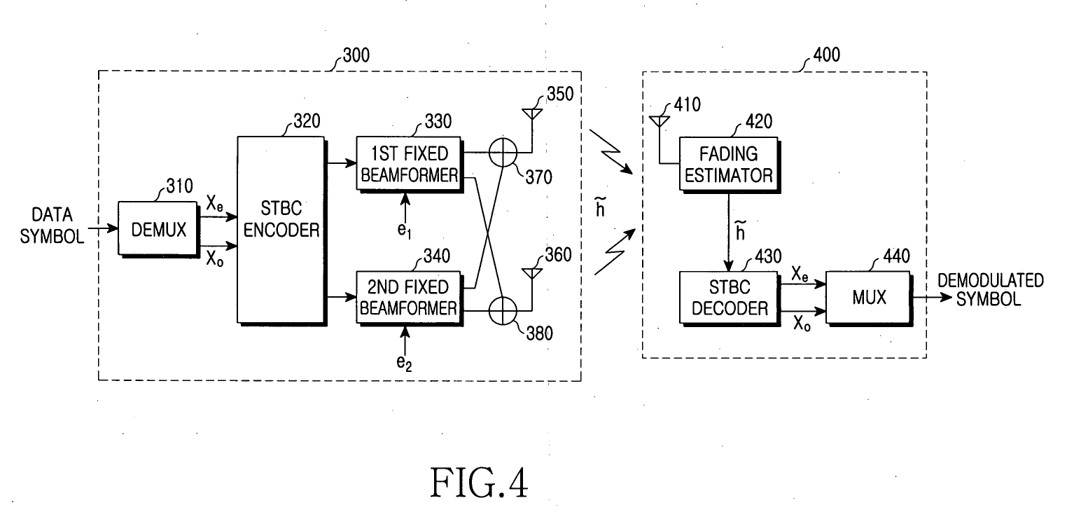

FIG. 4 is a block diagram of a transmit diversity system according to an alternative embodiment of the present invention. The transmit diversity system is comprised of, for example, a transmitter 300 and a receiver 400 which operate a common eigen space STBC scheme with two transmit antennas.

Referring to FIG. 4, the transmitter 300 is provided in a BS. At the transmitter 300, a demultiplexer (DEMUX) 310 demultiplexes data symbols for transmission into a transmission signal Xₑ for an even-indexed time slot and a transmission signal Xₒ for an odd-indexed time slot. A STBC encoder 320 STBC-encodes the transmission signals Xₑ and Xₒ. For the input of the STBC-coded signals, first and second fixed beamformers 330 and 340 form as many orthogonal fixed beams as the number of transmit antennas 350 and 360 using a common eigen basis set with elements e1 and e2, respectively. The transmit antennas 350 and 360, each of which is connected to the first and second fixed beamformers 330 and 340 via combiners 370 and 380, transmit the fixed beams over a radio network.

At the receiver 400, a fading estimator 420 connected to a receive antenna 410 estimates the beamformed channel signals and a STBC decoder 430 STBC-decodes the estimated channels. A multiplexer (MUX) 440 multiplexes the decoded signals and outputs demodulated symbols.

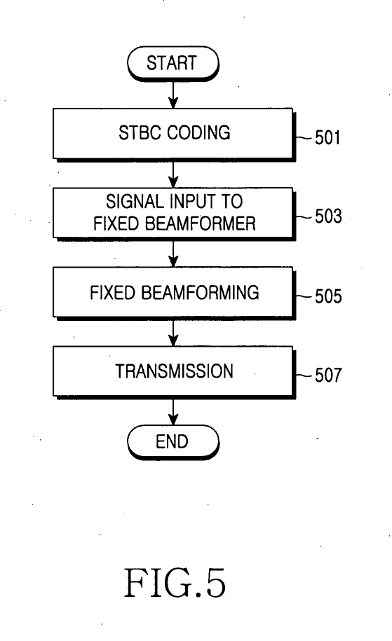

FIG. 5 is a flowchart illustrating a transmit diversity method according to the alternative embodiment of the present invention. The transmit diversity method transmits to the receiver 400 data symbols using the STBC block codes and the common eigen bases e₁ and e₂ in the common eigen space STBC scheme by the transmitter 300, and recovers the data symbols by STBC decoding at the receiver 400.

Referring to FIG. 5, the transmitter 300 demultiplexes a transmission signal and STBC-encodes the demultiplexed signals in step 501, and provides the STBC-coded signals to a plurality of fixed beamformers in step 503. In step 505, the fixed beamformers form fixed beams using the common eigen bases e₁ and e₂ as beamforming weights. The beamformed traffic signals are transmitted to the receiver 400 through a plurality of transmit antennas in step 507. This common eigen space STBC scheme will be described in great detail.

The STBC coding in step 501 is assumed to be the Alamouti STBC scheme applicable to a BS system with two transmit antennas. The present invention is not limited to the Alamouti STBC scheme and thus is applicable to all other STBC schemes.

In the common eigen space STBC scheme, the received signals are expressed as

$$[ \begin{matrix}{r}_{e} \\ {r}_{o}\end{matrix} ] = [ \begin{matrix}{he}_{1} {x}_{o} - {he}_{2} {x}_{e}^{*} \\ {he}_{1} {x}_{e} + {he}_{2} {x}_{o}^{*}\end{matrix} ] / \sqrt{2} = [ \begin{matrix}{η}_{1} \\ {η}_{2}\end{matrix} ] \qquad ( 13 )$$

The fading estimator 420 at the receiver 400 estimate fading channel coefficients \tilde{h}₁ and \tilde{h}₂ between the transmit antennas 350 and 360 and the receive antenna 410 from the fixed beams. The STBC decoder 430 carries out linear decoding using the fading estimates by

$$[ \begin{matrix}{\hat{x}}_{e} \\ {\hat{x}}_{o}\end{matrix} ] = [ \begin{matrix}{\tilde{h}}_{2}^{*} {r}_{e} - {\tilde{h}}_{1} {r}_{o}^{*} \\ {\tilde{h}}_{1}^{*} {r}_{e} + {\tilde{h}}_{2} {r}_{o}^{*}\end{matrix} ] \qquad ( 14 )$$

The MUX 440 multiplexes the decoded symbols \hat{x}ₑ and \hat{x}ₒ for even-indexed and odd-indexed time slots and outputs multiplexed demodulation symbols. The maximum SNR of the common eigen space STBC signal is given as

$${\tilde{γ}}_{STS} = \frac{{E}_{b}}{{N}_{o}} \frac{{\vert {\tilde{h}}_{1} \vert}^{2} + {\vert {\tilde{h}}_{2} \vert}^{2}}{2} \qquad ( 15 )$$

According to Eq. (15), because the mean and variance of hₖ are equal to those of \tilde{h}ₖ in a channel environment having a low channel spatial correlation, the common eigen space STBC has the same performance as does the conventional antenna space STS. For a channel having a high channel spatial correlation, the conventional antenna space STS has a SNR computed by

$${γ}_{STS} = \frac{{E}_{b}}{{N}_{o}} {\vert {h}_{1} \vert}^{2} \qquad ( 16 )$$

and for the common eigen space STBC, the SNR is

$${\tilde{γ}}_{STS} = \frac{{E}_{b}}{{N}_{o}} \frac{{\vert {\tilde{h}}_{1} \vert}^{2}}{2} \qquad ( 17 )$$

Because E[|\tilde{h}₁|²]=2E[|\tilde{h}₁|²], the common eigen space STBC and the conventional antenna space STS theoretically have the same average SNR even for a fading channel having a high channel spatial correlation. This implies that they theoretically have the same performance.

However, considering that the orthogonality of STBC codes is lost because of multipath fading in a real radio environment, the two schemes differ in SNR performance. The common eigen space STBC reduces the multipath fading of the radio channel by fixed beamforming. The resulting suppression of the orthogonality loss leads to a higher SNR than in the conventional antenna space STS in an urban area undergoing severe multipath fading.

Common Eigen Space TxAA

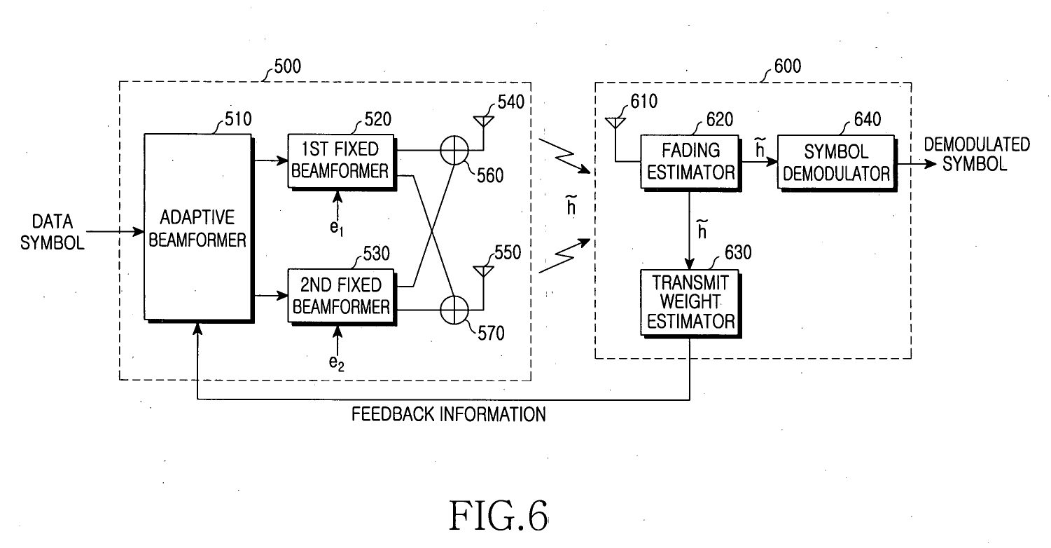

FIG. 6 is a block diagram of a transmit diversity system according to a further embodiment of the present invention. The transmit diversity system is comprised of, for example, a transmitter 500 and a receiver 600 which operate a common eigen space TxAA scheme with two transmit antennas.

Referring to FIG. 6, the transmitter 500 is provided in a BS. At the transmitter 500, first and second fixed beamformers 520 and 530 form as many orthogonal fixed beams as the number of transmit antennas 540 and 550 using a common eigen basis set with elements e1 and e2, respectively.

At the receiver 600, a fading estimator 620 connected to a receive antenna 610 estimates fading channel coefficients of the fixed beams, \tilde{h}₁ and \tilde{h}₂. When the signals received in the common eigen space at the receiver 600 is expressed as Eq. (18), a transmit weight estimator 630 determines a transmit weight vector w for use in the transmitter 500 using the estimated fading channel coefficients by Eq. (19) and feeds back the transmit weight vector w to the transmitter 500.
\tilde{r}_{TxAA}=hEw^{H}s+η=\tilde{h}w^{H}s+η (18)

The transmit weight vector w can be computed using the channel coefficient \tilde{h} that is estimated at the receiver 600 and fed back to the transmitter 500.
w=\tilde{h}/∥\tilde{h}∥ (19)

Therefore, an adaptive beamformer 510 at the transmitter 500 forms beams for data symbols using the transmit weight vector w and fixed beamformers 520 and 530 form fixed beams for the weighted data symbols w₁*s and w₂*s, respectively using common eigen bases e₁ and e₂. The transmit antennas 540 and 550, each being connected to the output terminals of the first and second fixed beamformers 520 and 530 via combiners 560 and 570, transmit the fixed beams over a radio network.

At the receiver, the fading estimator 620 estimates the beamformed fading channels and, at the same time, provides the received signals to a symbol demodulator 640. The symbol demodulator 640 demodulates the received signals.

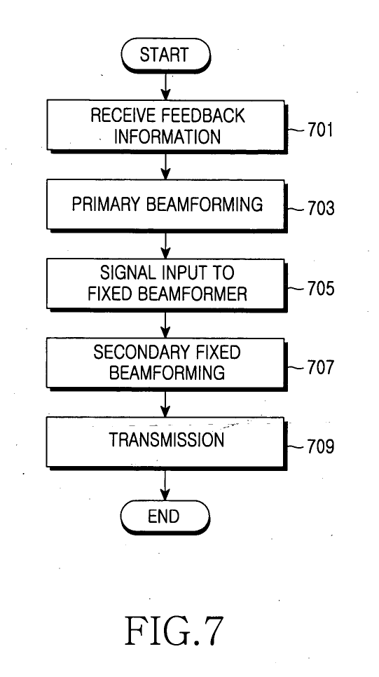

FIG. 7 is a flowchart illustrating a transmit diversity method according to the further embodiment of the present invention. The transmit diversity method is about transmitting data symbols to the receiver 600 in the common eigen space TxAA scheme by the transmitter 500 and feeding back a transmit weight vector to the transmitter 500 by the receiver 600.

Referring to FIG. 7, the transmitter 500 receives from the receiver 600 feedback information about a transmit weight vector for beamforming as determined by Eq. (19) in step 701 and forms a beam for data symbols using the transmit weight vector in step 703. In step 705, the transmitter 500 provides the beamformed signal to the fixed beamformers. Each fixed beamformer forms a fixed beam using a common eigen basis in step 707. In accordance with a further embodiment of the present invention, the primary beamforming is carried out using the feedback information about the transmit weight vector and the secondary beamforming is fixed beamforming using common eigen bases. In step 709, the transmitter 500 transmits the fixed beams through the transmit antennas over a radio network. The receiver 600 then estimates the fading channel coefficients of the fixed beams between the transmit antennas and the receive antenna, determines a transmit weight vector by Eq. (18) and Eq. (19), and feeds back the transmit weight vector to the transmitter 500.

The maximum SNR of the common eigen space TxAA signal is computed by

$${\tilde{γ}}_{TxAA} = \frac{{E}_{b}}{{N}_{o}} ( {\vert {\tilde{h}}_{1} \vert}^{2} + {\vert {\tilde{h}}_{2} \vert}^{2} ) \qquad ( 20 )$$

A comparison between Eq. (6) and Eq. (2) indicates that because the mean and variance of \tilde{h}ₖ are equal to those of \tilde{h}ₖ in a channel environment with a low channel spatial correlation, the common eigen space TxAA has the same performance as does the conventional antenna space TxAA. It also indicates that under a channel environment having a high channel spatial correlation,

$${γ}_{TxAA} = \frac{2 {E}_{b}}{{N}_{o}} {\vert {h}_{1} \vert}^{2} and {\tilde{γ}}_{TxAA} = \frac{{E}_{b}}{{N}_{o}} {\vert {\tilde{h}}_{1} \vert}^{2}$$

and thus both the common eigen space TxAA and the convention antenna space TxAA show the same average SNR gain but with no diversity gain, and theoretically have the same performance.

However, considering the decrease of transmit weight performance caused by the transmission errors and delay of the feedback information in the real radio environment, the two schemes differ in SNR performance. That is, in the high channel spatial correlation-radio environment, the average power delivered by one of the two common eigen bases from the transmitter 500 to the receiver 600 is higher than that of the other common eigen basis.

In accordance with a further embodiment of the present invention, for a given average transmit power, the common eigen space TxAA undergoes the decrease of the maximum SNR performance in the received signal as caused by the transmission errors and delay of feedback information less than the conventional antenna space TxAA. Consequently, the former shows better SNR performance than the latter in a radio environment where MSs move fast.

As described above, the embodiments of the present invention provide beamforming gain under a high channel spatial correlation environment and diversity gain under a low channel spatial correlation environment in a multiple-antenna mobile communication system.

In addition, the embodiments of the present invention form fixed beams that yield an increased average SNR gain, thereby improving system performance.

While the invention has been shown and described with reference to certain embodiments thereof, it will be understood by those skilled in the art that various changes in form and details may be made therein without departing from the spirit and scope of the invention as defined by the appended claims.

1. A diversity apparatus for a transmitter having a plurality of transmit antennas in a mobile communication system, comprising:
a plurality of fixed beamformers for forming fixed beam signals using a plurality of common eigen bases, each for one fixed beam signal; and
the plurality of transmit antennas for receiving the fixed beam signals from the fixed beamformers and transmitting the fixed beam signals over a radio network.
wherein each of the fixed beam signals is receivable in every part of a cell area.

2. The diversity apparatus of claim 1, wherein each of the fixed beam signals is receivable in every part of a cell area.

3. The diversity apparatus of claim 1, wherein the number of the common eigen bases is equal to the number of the transmit antennas.

4. The diversity apparatus of claim 1, wherein the plurality of common eigen bases are mutually orthogonal.

5. The diversity apparatus of claim 1, wherein the plurality of common eigen bases are time-invariant.

6. The diversity apparatus of claim 1, wherein each of the fixed beam signals is transmitted with the same transmit power.

7. The diversity apparatus of claim 1, wherein the common eigen bases are the eigen vectors of a transmit spatial correlation matrix R expressed as
$$R = {\int }_{- Δ / 2}^{Δ / 2} p ( θ ) {a}^{H} ( θ ) a ( θ ) ⅆ θ$$
where Δ is a sector radius of the transmit antennas, p(θ) is a radiation pattern of the transmit antennas, a(θ) is a response vector of the transmit antennas, a(θ)=[1,exp(j2πd_{T} sin θ/λ . . . exp(j2π(n_{T}−1)d_{T} sin θ/λ)], n_{T} is a number of the transmit antennas, d_{T} is an antenna spacing, and λ is a wavelength of a carrier.

8. The diversity apparatus of claim 1, further comprising a switch for receiving feedback information about a selected common eigen basis from a receiver and switching the selected common eigen basis to a fixed beamformer using the selected common eigen basis as a beamforming weight.

9. The diversity apparatus of claim 8, wherein the feedback information is determined by
$${γ}_{STD} = max ( \frac{{E}_{b}}{{N}_{o}} {\vert {h}_{1} \vert}^{2} , \frac{{E}_{b}}{{N}_{o}} {\vert {h}_{2} \vert}^{2} , … , \frac{{E}_{b}}{{N}_{o}} {\vert {h}_{n} \vert}^{2} )$$
where E_{b} is signal energy, Nₒ is noise energy, and hₙ is a multipath fading channel coefficient from an n^{th} transmit antenna to a receive antenna of the receiver.

10. The diversity apparatus of claim 1, further comprising a space-time block code (STBC) encoder for STBC-encoding a plurality of signals demultiplexed from data symbols and providing STBC-coded signals to the plurality of fixed beamformers.

11. The diversity apparatus of claim 10, wherein the STBC encoder STBC-encodes the signals using an Alamouti code.

12. The diversity apparatus of claim 1, further comprising an adaptive beamformer for receiving feedback information about a transmit weight estimated by the receiver from the receiver, generating an adaptive beam signal according to the feedback information, and providing the adaptive beam signal to the plurality of fixed beamformers.

13. The diversity apparatus of claim 12, wherein the adaptive beamformer performs a primary beamforming using a transmit weight and the plurality of fixed beamformers perform secondary fixed beamforming using the common eigen bases.

14. The diversity apparatus of claim 12, wherein the transmit weight is computed by
w=\tilde{h}/∥\tilde{h}∥
where \tilde{h} is a vector comprising estimated fading channel coefficients of the fixed beam signals from the transmit antennas to the receive antenna and ∥ ∥ is an norm operator that computes the value of a vector.

15. A diversity apparatus for a receiver in a mobile communication system, the receiver receiving radio data symbols from a transmitter that has a plurality of transmit antennas and forms fixed beams in a common eigen space using common eigen bases corresponding to the transmit antennas as weights, comprising:
an antenna for transmitting and receiving data over a radio network;
a fading estimator for estimating at least one of fading channels formed by a plurality of fixed beams; and
a basis selector for measuring the instantaneous power levels of the estimated fading channels and feeding back information about the common eigen basis of a fading channel having the highest instantaneous power level to the transmitter.

16. The diversity apparatus of claim 15, wherein the feedback information is determined by
$${γ}_{STD} = max ( \frac{{E}_{b}}{{N}_{o}} {\vert {h}_{1} \vert}^{2} , \frac{{E}_{b}}{{N}_{o}} {\vert {h}_{2} \vert}^{2} , … , \frac{{E}_{b}}{{N}_{o}} {\vert {h}_{n} \vert}^{2} )$$
where E_{b} is signal energy, Nₒ is noise energy, and hₙ is a multipath fading channel coefficient from an n^{th} transmit antenna to the antenna of the receiver.

17. A diversity apparatus for a receiver in a mobile communication system, the receiver receiving radio data symbols from a transmitter that has a plurality of transmit antennas and forms fixed beams in a common eigen space using common eigen bases corresponding to the transmit antennas as weights, comprising:
an antenna for transmitting and receiving data over a radio network;
a fading estimator for estimating at least one of fading channels formed by a plurality of fixed beams;
a space-time block code (STBC) encoder for STBC-encoding data symbols received on the at least one estimated fading channel; and
a multiplexer for multiplexing STBC-encoded signals.

18. The diversity apparatus of claim 17, wherein the STBC encoder STBC-encodes the signals using an Alamouti code.

19. A diversity apparatus for a receiver in a mobile communication system, the receiver receiving radio data symbols from a transmitter that has a plurality of transmit antennas and forms fixed beams in a common eigen space using common eigen bases corresponding to the transmit antennas as weights, comprising:
an antenna for transmitting and receiving data over a radio network;
a fading estimator for estimating at least one of fading channels formed by a plurality of fixed beams; and
a transmit weight estimator for estimating a transmit weight from the at least one estimated fading channel, for use in beamforming in the transmitter and feeding back information about the transmit weight estimate to the transmitter.

20. The diversity apparatus of claim 19, wherein the transmit weight is estimated by
w=\tilde{h}/∥\tilde{h}∥
where \tilde{h} is a vector comprising estimated fading channel coefficients of the fixed beam signals from the transmit antennas of the transmitter to the antenna of the receiver and ∥ ∥ is an operator that computes the value of a vector.

21. A method of providing transmit diversity to a receiver in a transmitter having a plurality of transmit antennas, comprising the steps of:
receiving from the receiver feedback information about a common eigen basis of a fading channel estimated at the receiver among a plurality of common eigen bases;
selecting at least one of a plurality of fixed beamformers based on the feedback information and inputting data symbols for transmission to the selected fixed beamformer;
forming a fixed beam signal using the common eigen basis using a weight through the selected fixed beamformer; and
transmitting the fixed beam signal through the transmit antennas over a radio network.

22. The method of claim 21, wherein each of fixed beam signals from the fixed beamformers is receivable in every part of a cell area.

23. The method of claim 21, wherein the number of the common eigen bases is equal to the number of the transmit antennas.

24. The method of claim 21, wherein the common eigen bases are time-invariant and common to all receivers.

25. The method of claim 21, wherein each of fixed beam signals formed using the common eigen bases is transmitted with the same transmit power.

26. The method of claim 21, wherein the common eigen bases are the eigen vectors of a transmit spatial correlation matrix R expressed as
$$R = {\int }_{- Δ / 2}^{Δ / 2} p ( θ ) {a}^{H} ( θ ) a ( θ ) ⅆ θ$$
where Δ is a sector radius of the transmit antennas, p(θ) is a radiation pattern of the transmit antennas, a(θ) is a response vector of the transmit antennas, a(θ)=[1,exp(j2πd_{T} sin θ/λ) . . . exp(j2π(n_{T}−1)d_{T} sin θ/λ)], n_{T} is a number of the transmit antennas, d_{T} is an antenna spacing, and λ is a wavelength of a carrier.

27. The method of claim 21, wherein the feedback information is determined by
$${γ}_{STD} = max ( \frac{{E}_{b}}{{N}_{o}} {\vert {h}_{1} \vert}^{2} , \frac{{E}_{b}}{{N}_{o}} {\vert {h}_{2} \vert}^{2} , … , \frac{{E}_{b}}{{N}_{o}} {\vert {h}_{n} \vert}^{2} )$$
where E_{b} is signal energy, Nₒ is noise energy, and hₙ is a multipath fading channel coefficient from an n^{th} transmit antenna to a receive antenna of the receiver.

28. A method of providing transmit diversity to a receiver in a transmitter having a plurality of transmit antennas, comprising the steps of:
space-time block code (STBC)-encoding data symbols for transmission;
providing STBC-coded signals to a plurality of fixed beamformers;
forming the STBC-coded signals into fixed beam signals using common eigen bases through the fixed beamformers; and
transmitting the fixed beam signals through the transmit antennas over a radio network.

29. The method of claim 28, wherein each of the fixed beam signals from the fixed beamformers is receivable in every part of a cell area.

30. The method of claim 28, wherein the number of the common eigen bases is equal to the number of the transmit antennas.

31. The method of claim 28, wherein the common eigen bases are time-invariant and common to all receivers.

32. The method of claim 28, wherein the transmission step comprises the step of transmitting each of the fixed beam signals formed using the common eigen bases with the same transmit power.

33. The method of claim 28, wherein the common eigen bases are the eigen vectors of a transmit spatial correlation matrix R expressed as
$$R = {\int }_{- Δ / 2}^{Δ / 2} p ( θ ) {a}^{H} ( θ ) a ( θ ) ⅆ θ$$
where Δ is a sector radius of the transmit antennas, p(θ) is the radiation pattern of the transmit antennas, a(θ) is the response vector of the transmit antennas, a(θ)=[1,exp(j2πd_{T} sin θ/λ) . . . exp(j2π(n_{T}−1)d_{T} sin θ/λ)], n_{T} is the number of the transmit antennas, d_{T} is an antenna spacing, and λ is the wavelength of a carrier.

34. The method of claim 28, wherein the STBC encoding step comprises the step of STBC-encoding the data symbols using an Alamouti code.

35. A method of providing transmit diversity to a receiver in a transmitter having a plurality of transmit antennas, comprising the steps of:
receiving from the receiver feedback information about a transmit weight estimated at the receiver for use in beamforming in the transmitter;
performing a primary beamforming using the transmit weight;
providing the primary beamformed signal to a plurality of fixed beamformers;
performing a secondary beamforming using common eigen bases through the fixed beamformers and outputting fixed beam signals; and
transmitting the fixed beam signals over a radio network through the transmit antennas.

36. The method of claim 35, wherein each of the fixed beam signals from the fixed beamformers is receivable in every part of a cell area.

37. The method of claim 35, wherein the number of the common eigen bases is equal to the number of the transmit antennas.

38. The method of claim 35, wherein the common eigen bases are time-invariant and common to all receivers.

39. The method of claim 35, wherein the transmission step comprises the step of transmitting each of the fixed beam signals formed using the common eigen bases with the same transmit power.

40. The method of claim 35, wherein the transmit weight for the primary beamforming is determined by
w=\tilde{h}/∥\tilde{h}∥
where \tilde{h} is a vector comprising estimated fading channel coefficients of the fixed beam signals from the transmit antennas of the transmitter to a receive antenna of the receiver and ∥ ∥ is an norm operator that computes the value of a vector.

41. The method of claim 35, wherein the common eigen bases are the eigen vectors of a transmit spatial correlation matrix R expressed as
$$R = {\int }_{- Δ / 2}^{Δ / 2} p ( θ ) {a}^{H} ( θ ) a ( θ ) ⅆ θ$$
where Δ is a sector radius of the transmit antennas, p(θ) is a radiation pattern of the transmit antennas, a(θ) is a response vector of the transmit antennas, a(θ)=[1,exp(j2πd_{T} sin θ/λ) . . . exp(j2π(n_{T}−1)d_{T} sin θ/λ)], n_{T} is a number of the transmit antennas, d_{T} is an antenna spacing, and λ is a wavelength of a carrier.
